(19) United States
(12) Patent Application Publication
(10) Pub. No.: US 2017/0287097 A1
(43) Pub. Date: Oct. 5, 2017

(54) HYBRID CLIENT-SERVER RENDERING IN A VIRTUAL REALITY SYSTEM

(71) Applicant: ATI TECHNOLOGIES ULC, Markham (CA)

(72) Inventor: I-Cheng Chen, Markham (CA)

(21) Appl. No.: 15/084,184

(22) Filed: Mar. 29, 2016

(51) Int. Cl. G06T 1/20; H04L 29/06; G06T 19/00

(52) U.S. Cl. CPC G06T 1/20; G06T 19/006; H04L 67/42

(57) ABSTRACT

A server partitions a model representative of a scene into a first portion and a second portion based on proximities of objects within the scene to a client device, renders a first portion of an image representative of the scene based on the first portion of the model, and transmits information representative of the second portion of the model and the first portion of the image over a wireless or wired network. The client device receives information representative of the second portion of the model and the first portion of the image. The client device renders the second portion of the image based on the second portion of the model and combines the first and second portions of the image.

### BACKGROUND

### Field of the Disclosure

The present disclosure relates generally to processing systems and, more particularly, to rendering graphics in a processing system.

### Description of the Related Art

Conventional virtual-reality or augmented-reality systems typically utilize a high-performance server in a host processing system to render graphics that are transmitted to a client device such as a smartphone, tablet, or head mounted device. A physical cable is often used to convey the rendered graphics from the host processing system to the client device, which then displays the rendered graphics to a user. However, users of virtual-reality or augmented reality systems move around and the physical cable can become an inconvenience, e.g., by wrapping around the body of the user. A wireless communication link can be established between the host processing system and the client device to remove the need for a physical cable. However, the wireless communication link has a larger latency between user actions and modifications to the displayed image. This increase in the “motion-to-photon” delay increases the overall response time of the system to user actions or motions and may interfere with the user's sense of immersion. The drawbacks to using a physical cable or a wireless communication link to convey rendered graphics between a host processing system and a client device can be eliminated by implementing the virtual-reality or augmented reality system on the client device. However, a self-contained client device typically does not support the same amount of computing power as a host processing system. For example, a smartphone does not have the same level of processing power as a desktop computer and consequently the smartphone may not be able to render graphics with the same level of detail and accuracy as the desktop computer, which may result in a reduced sense of immersion.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless image processing and display system according to some embodiments.

FIG. 2 is a diagram that illustrates a model that is used to generate an image for display on a client device according to some embodiments.

FIG. 3 is a diagram illustrating images that are rendered by a client device and a server, respectively, and a merged image generated by the client device according to some embodiments.

FIG. 4 illustrates a merged image that is produced by a client device by merging a locally rendered foreground image with a background image that is rendered by a server according to some embodiments.

FIG. 5 is a diagram illustrating information exchanged between a server and a client device that together implement hybrid client-server rendering according to some embodiments.

FIG. 6 is a flow diagram of a method for partitioning a model into background and foreground portions that are rendered on a server and a client device, respectively, according to some embodiments.

FIG. 7 is a flow diagram of a method for rendering a foreground portion of an image from a corresponding foreground portion of a model and merging the rendered foreground portion with a background portion of the image that is rendered on a server according to some embodiments.

FIG. 8 is a block diagram of a wireless image processing and display system that implements hybrid client/server rendering according to some embodiments.

### DETAILED DESCRIPTION

The competing demands for user mobility and an immersive virtual reality or augmented reality environment can be addressed by selectively rendering a first portion of an image on a host processing system and a second portion of the image on a client device, which then merges the first and second portions of the image for display to a user. The first portion may be referred to as a “background” portion of the image and the second portion may be referred to as a “foreground” portion of the image. The host processing system generates a model of a scene that is to be rendered and then selects portions of the model that are to be rendered by the host processing system or the client device based on proximity of objects represented by the portions of the model to the user. For example, the foreground of a scene may include the hands of a character and a steering wheel of a car in a driving game played by the user and the background of the scene may include a road through a mountain pass. The host processing system renders the background of the scene using the background portions of the model and the client device renders the foreground of the scene using foreground portions of the model such as models of the character's hands and the steering wheel. Some embodiments of the host processing system may also select portions of the model of the scene for rendering at the client device based on a rate of change of the portion the model. For example, a rapidly moving car that passes in front of the user's car may be selectively rendered on the client device because of the high rate of change of the portion of the model that represents the rapidly moving car. Oscillation, rotation, vibration, fluctuating lighting, and the like may also lead to a high rate of change of a portion of the model.

The host processing system may provide, for example, three types of information to the client device: (1) reference information such as a coordinate system that is used to align the background and foreground portions of an image rendered by the host processing system and the client device, respectively, (2) model information defining a foreground portion of the model that is used by the client device to render the foreground portion of the image, and (3) rendered graphics that represent the background portion of the image rendered by the host processing system based the background portion of the model. The client device acquires motion data representative of movement of the client device and uses this information to render its portion of the image using the provided model information. Some embodiments of the client device also provide motion data to the host processing system, which uses the motion data during the rendering. The client device combines the locally rendered image with the rendered image provided by the host processing system based on the alignment information. Some embodiments of the client device apply a “time warp” correction to the rendered image provided by the host processing system to account for user motion as indicated by the motion data. The sense of immersion produced by the hybrid client/server rendering technique may be improved because the motion-to-photon latency is reduced for nearby, fast-moving, or rapidly changing portions of the scene, while the host processing system can perform the bulk of the graphics rendering on portions of the model that are further from the user or slower moving. The bandwidth consumed by the communication link between the host processing system and the client device may also be reduced because the model information and the alignment information may be transmitted relatively infrequently compared to the graphics rendered at the host processing system.

Dividing the processing work between a locally rendered foreground portion and a remotely rendered background portion can balance the competing demands for low latency, a strong sense of immersion, and high viewing quality. The user is always more sensitive to motion or changes in the foreground portions of a scene that are closer to the eyes and less sensitive to motion or changes in the background portion of the scene. The latency is therefore minimized and the sense of immersion is optimized by rendering features that are closest to the user locally on the client device. Rendering the background portion of the scene on the remote host provides the best viewing quality of the scenes.

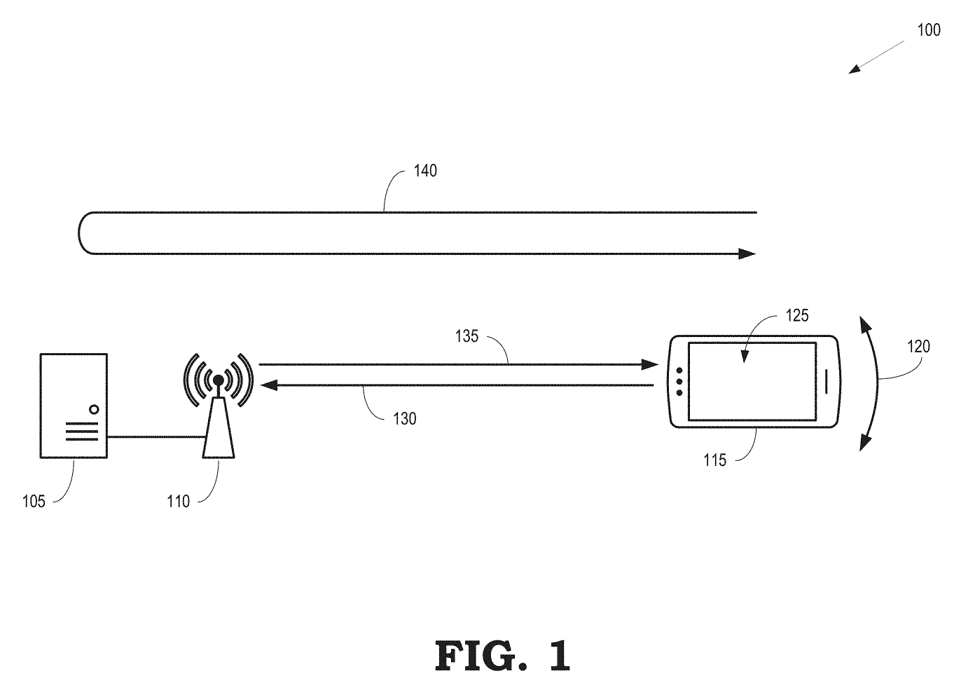

FIG. 1 is a diagram of a wireless image processing and display system 100 according to some embodiments. The wireless image processing and display system 100 includes a server 105 that is connected to a base station 110 that provides wireless connectivity over an air interface. The server 105 includes one or more processors that are configured to render images from models that represent objects in the scenes that are presented in the images. The objects in the model used by the server 105 may be represented as a collection of points in a two-dimensional or three-dimensional space and the points may be connected by lines to form a polygon mesh. For example, a three dimensional model of objects in a scene may be represented as a collection of triangles formed by three vertices connected by a corresponding set of three lines. The three dimensional model can be transformed into screen space, e.g., by projecting the three dimensional model into the plane of the screen used to display the image to a user. Portions of the polygons can be assigned to regions of the screen such as tiles that are formed of 16×16 pixel arrays or 32×32 pixel arrays. The server 105 can then render the portion of the image corresponding to each tile separately or concurrently with rendering other portions of the image corresponding to other tiles, e.g., using multiple processors operating in parallel.

The wireless image processing and display system 100 also includes a client device 115 that communicates with the server 105 over the air interface via the base station 110. The client device 115 may be a smart phone, portable game console, head mounted display, or other user-portable device that is used to display virtual reality or augmented reality images to a user. During operation, actions by the user may result in movement of the client device 115, as indicated by the double-headed arrow 120. Movement may be indicated by motion in a three dimensional space, e.g., changes in XYZ coordinates of the client device 115, as well as changes in a pitch, roll, or yaw of the client device 115. Some embodiments of the client device 115 include elements such as accelerometers, Global Positioning System (GPS) devices, and the like that are used to acquire motion data representative of movement of the client device 115. The client device 115 may also be able to determine a rate of change of the motion data. For example, the client device 115 may be able to determine a velocity of the client device 115, an angular velocity of the client device 115, and the like.

The client device 115 includes a screen 125 for displaying images to a user. The screen 125 may be a single element that is used to provide a single image to both eyes of the user or the screen 125 may include a pair of elements: one that provides an image to a right eye of the user and one that provides an image to the left eye of the user. The images may be taken from offset viewpoints to produce a stereoscopic 3-D image. In the interest of clarity, some embodiments disclosed herein are described in the context of a screen 125 that provides a single image. However, embodiments of the techniques disclosed herein are also applicable to screens that provide multiple images to generate stereoscopic 3-D images. For example, the reference points for two screens used in a virtual reality or augmented reality HMD may be offset by a distance corresponding to the separation of the right and left eyes of a typical user. Positions of the objects in the images may then be determined relative to the two reference points.

The images displayed on a screen 125 of the client device 115 depend upon the motion of the client device 115. For example, a background image representative of objects in the far distance should maintain the same orientation regardless of any rotation of the client device 115. The background image displayed on the screen 125 should be counter-rotated to compensate for rotation of the client device 115. The client device 115 may therefore transmit motion data to the server 105 over an uplink 130 of the air interface. The server 105 uses the motion data to render images from the model of the scene and returns the rendered images to the client device 115 over a downlink 135 of the air interface.

The time that elapses between acquisition and transmission of the motion data from the client device 115, rendering of the images by the server 105, and display of the rendered images on the screen 125 of the client device 115 is referred to as the “motion-to-photon” latency 140 of the wireless image processing and display system 100. The motion-to-photon latency 140 should be less than or on the order of 20 milliseconds (ms) so that users of the client device 115 do not perceive any lag between movement of the client device 115 and corresponding changes in the displayed image. This limit on the motion-to-photon latency 140 may be difficult or impossible to meet, particularly for objects that are near the client device 115 or are rapidly changing, due to the delays introduced by processing in the server 105, the base station 110, and the client device 115.

Portions of the image that are rendered based on portions of the model that are further from the client device 115 (e.g., background portions) are less affected by the motion-to-photon latency 140 than portions of the image that are rendered based on portions of the model that are in closer proximity to the client device 115 (e.g., foreground portions). The observable effects of the motion-to-photon latency 140 on the images displayed on the screen 125 of the client device 115 can therefore be reduced or eliminated by selectively rendering background portions of the image on the server 105 using background portions of the model and rendering foreground portions of the image on the client device 115 using foreground portions of the model. The background and foreground portions of the image may then be merged by the client device 115 to generate an image for display on the screen 125. Some embodiments of the server 105 partition the model representative of the scene into a first portion that is to be used by the server 105 to render background portions of the image and a second portion that is to be transmitted to the client device 115 for rendering the foreground portions of the image. Motion data acquired by the client device 115 can then be used to render the foreground portions of the image with substantially no motion-to-photon latency since the feedback path from acquisition of the motion data to rendering of the foreground portion of the image is entirely within the client device 115. In some embodiments, rates of change of portions of the model may also be used to partition the model into the first and second portions.

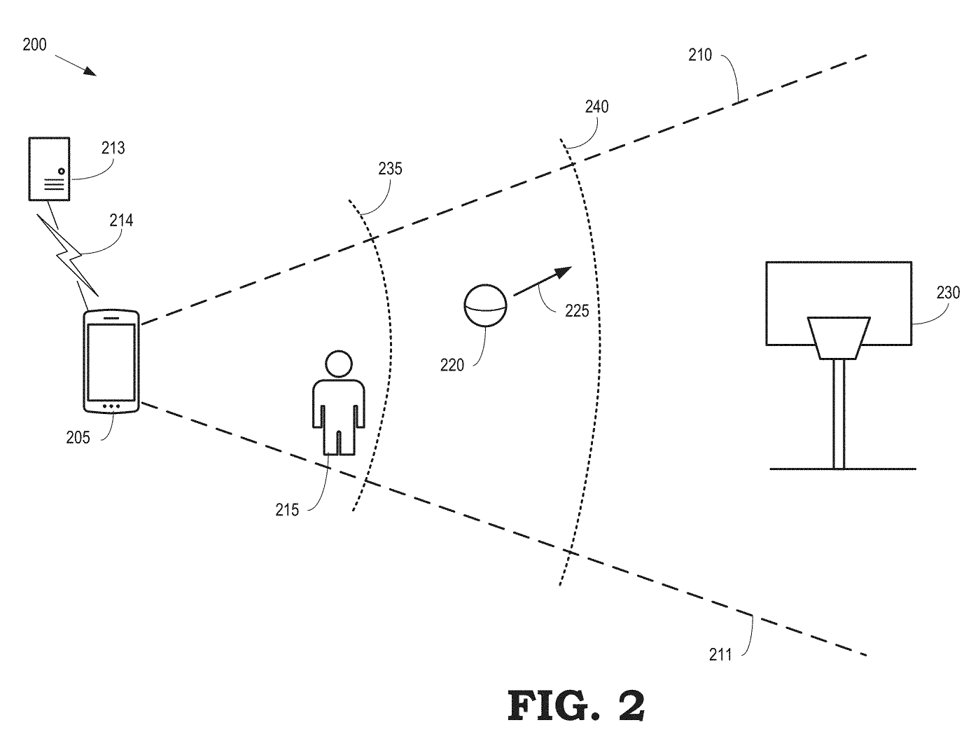

FIG. 2 is a diagram that illustrates a model 200 that is used to generate an image for display on a client device 205 according to some embodiments. The location of the client device 205 provides a reference point (which may also be referred to as a point-of-view) for determining the proximity of portions of the model 200 to a user of the client device 205. As discussed herein, the client device 205 may support two display screens that provide different images to the right eye and left eye of the user to generate a stereoscopic image. In that case, the client device 205 may include two reference points offset by a distance corresponding to a separation between a right eye and a left eye and these two reference points may be used to determine the proximity of portions of the model 200 to the right eye and the left eye of the user. A field-of-view of the client device 205 is indicated by the dashed lines 210, 211.

In the illustrated embodiment, the model 200 is used to generate images for display on the client device 205 as part of a game, which may be implemented on a server 213 that is connected to the client device 205 by a wireless communication link over an air interface 214. The model 200 includes a first portion that represents a player 215, which may be a player controlled by the user in a third-person game, a player controlled by another user in a cooperative game, or a player controlled by an artificial intelligence module implemented by the game. The model 200 also includes a second portion that represents a ball 220 that is moving with a velocity indicated by the arrow 225. The model 200 further includes a third portion that represents a basketball hoop 230. The model 200 indicates the positions of the objects 215, 220, 230 relative to the client device 205.

The server 213 partitions the model 200 into foreground and background portions based on proximities of objects represented by the portions of the model 200 to the reference point (or points) established by the client device 205. Some embodiments of the server 213 use a threshold distance 235 to partition the model 200 into a foreground portion that is within the threshold distance 235 of the client device 205 and a background portion that is beyond the threshold distance of 235 from the client device 205. For example, portion of the model 200 that represents the player 215 may be included in the foreground portion and the portion of the model 200 that represents the basketball hoop 230 may be included in the background portion. The partition of the model 200 may also take into account a rate of change of portions of the model 200. For example, a rapidly moving object such as the portion of the model 200 that represents the ball 220 moving at the velocity 225 may be included in the foreground portion. The ball 220 may be included in the foreground portion if the velocity 225 is above a threshold velocity or if the ball 220 is within a threshold distance 240 that is further from the client device 205 than the threshold distance 235 that is applied to slower moving or stationary portions of the model 200.

The server 213 may be configured to render portions of the image represented by the background portion of the model 200. The rendered background portions of the image can then be transmitted to the client device 205 over the air interface 214. The server 213 may also transmit information that is used to define the foreground portion of the model 200 to the client device 205, which may render a foreground portion of the image based on the information defining the foreground portion of the model 200. The server 213 further transmits information that is used to align the rendered foreground and background portions of the images. For example, the alignment information may include information defining a coordinate system. Coordinates of the coordinate system may then be used to define a position of the basketball hoop 230, a position of the player 215 (or an initial position, if the player 215 is expected to move), a position of the ball 220 (or an initial position, if the ball 220 is expected to move).

The client device 205 renders a foreground portion of the image based on the foreground portion of the model 200. For example, the client device 205 renders an image based on the model of the player 215 and the ball 220. The client device 205 may also compute changes in the position or orientation of the foreground portions of the model 200. For example, the client device 205 may implement a physics engine that uses physical characteristics of the foreground portions of the model 200 (which may be provided by the server 213) to compute the changing position or orientation of the ball 220 as it travels from the player 215 towards the basketball hoop 230. This allows the client device 205 to render the foreground portion of the image over an extended time interval without further input from the server 213. The client device 205 may then merge the rendered foreground and background portions of the image to produce an image for display on the client device 205.

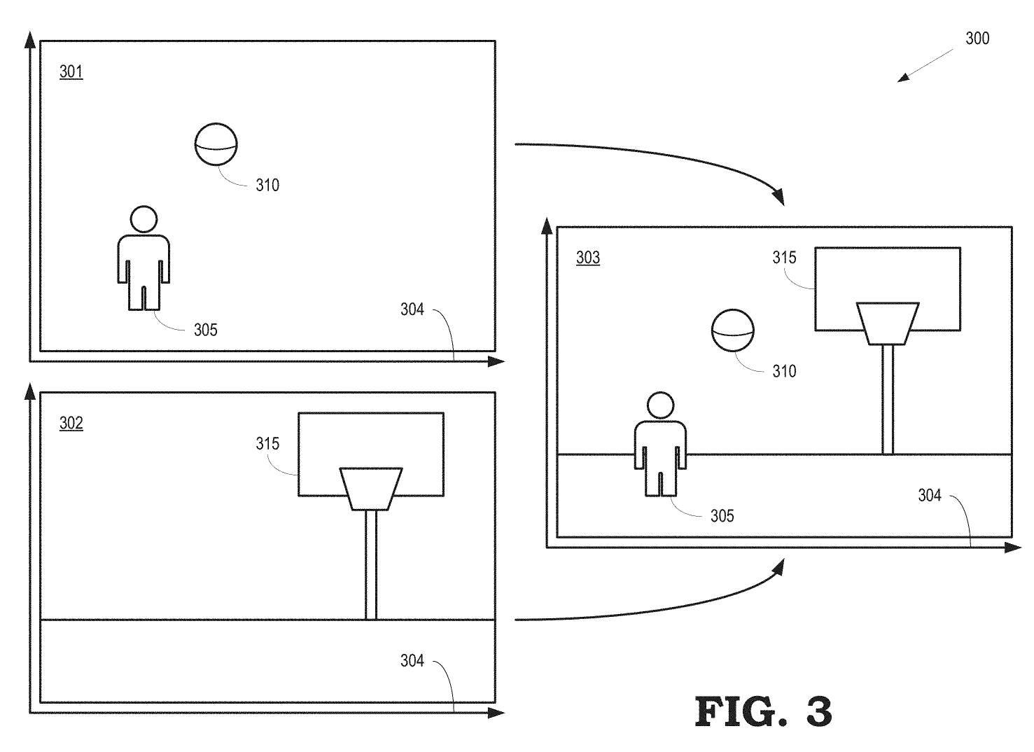

FIG. 3 is a diagram illustrating images 301, 302 that are rendered by a client device and a server, respectively, and a merged image 303 generated by the client device according to some embodiments. The image 301 rendered by the client device includes portions 305, 310 that are rendered based on foreground portions of a model such as the player 215 and the ball 220, respectively. The image 302, which is rendered by the server and transmitted to the client device over an air interface, includes a portion 315 that is rendered based on background portions of the model such as the basketball hoop 230 shown in FIG. 2. Rendering the portions 305, 310, 315 of the images 301, 302 may include rendering tiles based on polygons that represent the foreground and background portions of the model, applying textures to the rendered tiles, lighting the rendered tiles, and the like.

The client device merges the images 301, 302 to produce the merged image 303. Some embodiments of the client device merge the images 301, 302 based on a common coordinate system 304 that is provided to the client device by the server. For example, the portions 305, 310, 315 of the images 301, 302 may be positioned within the images 301, 302 on the basis of their coordinates within the common coordinate system 304. Registering may also be used to align the images 301, 302, e.g., using information provided by the server that indicates specific points within the images 301, 302 that should be aligned (or registered) so that the images 301, 302 have the proper position and orientation relative to each other.

In some cases, tiles in the image 301 may correspond to the same location or pixel on the display as tiles in the image 302. Relational information may then be used to determine which tile (or combination of tiles) is used to determine the characteristics of the merged image 303 at the common location or pixel. For example, tiles from the foreground image 301 may be used to determine the characteristics of merged image 303 when the foreground image 301 and the background image 302 overlap at a common location or pixel. For another example, tiles from the foreground image 301 and the background image 303 may be combined based on their relative transparencies to determine the characteristics of the merged image 303 at the common location or pixel. Some embodiments of the server provide the client device with relational information that indicates the relations of the portions 305, 310, 315. Examples of relational information include information indicating portions of the images 301, 302 that are in front of or behind other portions, information indicating portions that are on top of or under other portions, transparencies of the portions, and the like.

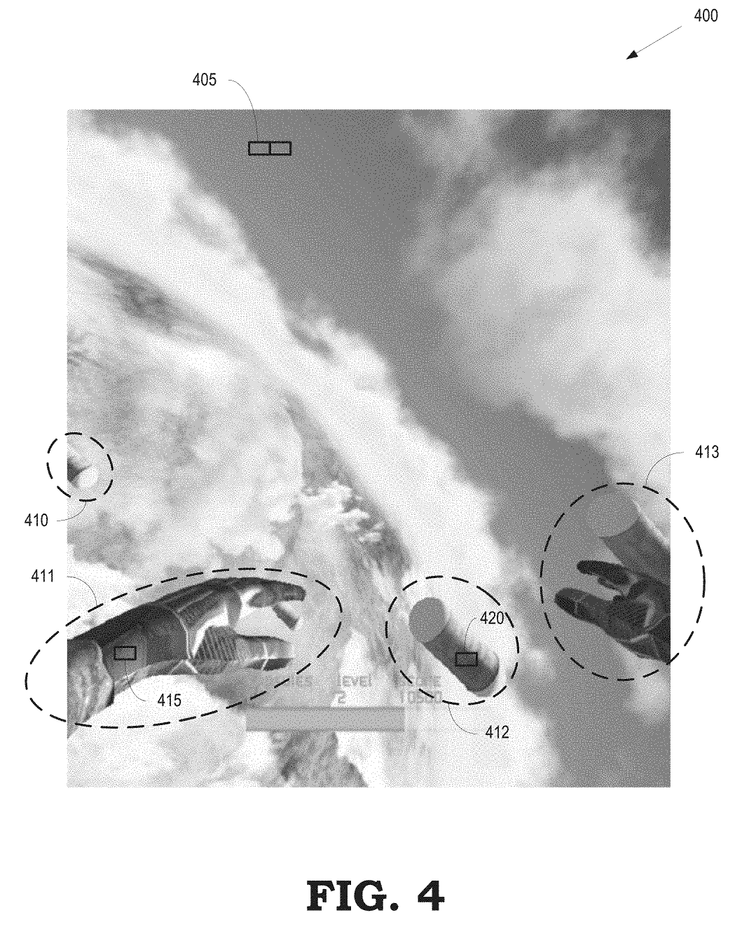

FIG. 4 illustrates a merged image 400 that is produced by a client device by merging a locally rendered foreground image with a background image that was rendered by a server according to some embodiments. The background image includes tiles 405 that are rendered by a server based upon a model, e.g., a model of the background sky and clouds. The rendered tiles 405 are transmitted to the client device over an air interface, as discussed herein. The foreground image includes portions 410, 411, 412, 413 (which are referred to collectively as “the portions 410-413”) representative of gloved hands and canisters. The portions 410-413 include tiles 415, 420 that are rendered by the client device using information defining models of the gloved hands and canisters. The client device also uses movement information to render the portions 410-413 of the foreground image. Some embodiments of the client device use the movement information to modify (or “time warp”) the background portion based on the most recently acquired movement information. For example, if the client device changes position or orientation between the time the client device fed back the most recent movement information to the server and the time the client device receives and displays the rendered background tiles 405, the client device can modify the position or orientation of the background tiles 405 to reflect the most recent movements. The movement information may also include information indicating movement of the canisters or the gloved hands, which may be indicated by the model or other devices such as motion-capture gloves worn by the user.

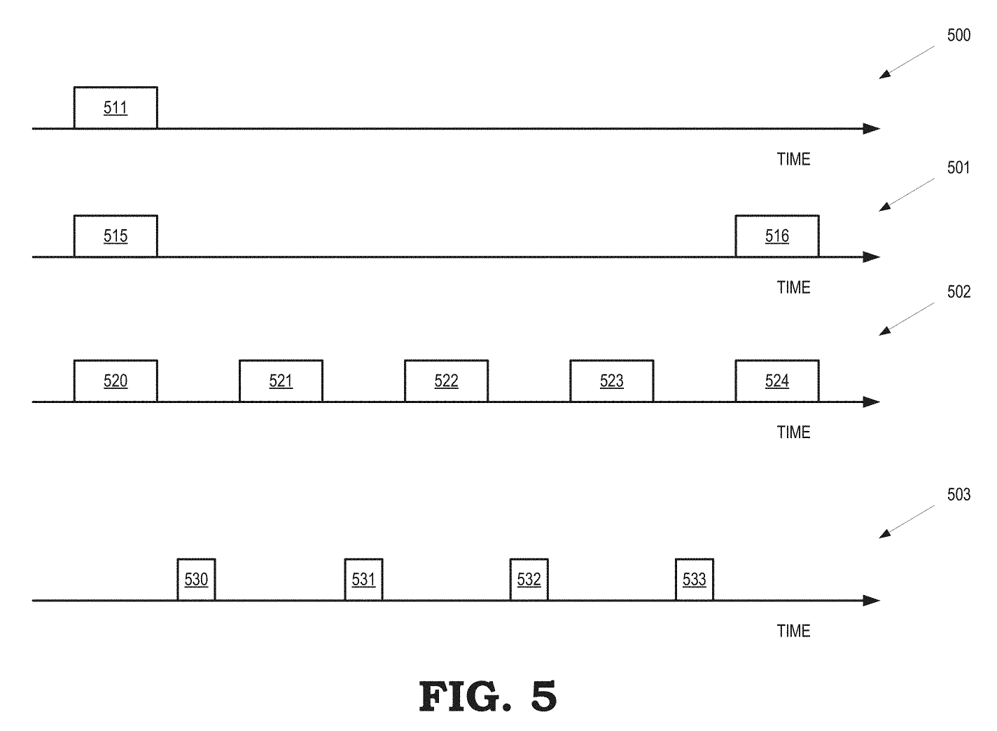

FIG. 5 is a diagram illustrating an information exchange between a server and a client device that implement hybrid client-server rendering according to some embodiments. The information exchange can be implemented in some embodiments of the server 105 and client device 115 shown in FIG. 1 or the server 213 and the client device 205 shown in FIG. 2. Time increases from left to right in FIG. 5. The time series 500, 501, 502, 503 illustrate three different types of information that are transmitted from the server to the client device and feedback provided from the client device to the server. Some embodiments of the time series 500-503 represent information that is transmitted over different uplink or downlink channels of the air interface.

The time series 500 depicts a block 511 that represents the transfer of coordinate information that is used to align the portions of the image that are rendered by the server and the client device. The coordinate information of the block 511 is transmitted from the server to the client device at the lowest frequency. For example, the coordinate system information in the block 511 may only be provided to the client device once for the duration of the game or scenario that is depicted in the image.

The time series 501 depicts blocks 515, 516 that represent the transfer of information use to define portions of a model that are to be used by the client device to render corresponding portions of the image. For example, the block 515 may include information defining a foreground portion of a model or a portion of the model that has a high rate of change. The portions of the model that are required by the client device may change over time. For example, a portion of the model that was previously in the background may move into the foreground due to motion of the client device or the portion of the model. For another example, a stationary portion of the model may begin to move and may therefore be added to the portion of the model that is rendered by the client device. Portions of the model that were previously in the foreground may also move to the background or their rate of change may decrease so that they can be rendered efficiently by the server. These portions may be removed from the portion of the model that is rendered by the client device. The block 516 may therefore include updated definitions of the model that is to be used by the client. The definitions of the model may be updated in response to the server modifying the partition of the model into portions that are rendered on the server and the client device.

The time series 502 depicts blocks 520, 521, 522, 523, 524 (referred to collectively herein as “the blocks 520-524”) that represent transfer of the portions of the image rendered by the server. The blocks 520-524 may be provided at a higher frequency than the block 511 or the blocks 515, 516. For example, the blocks 520-524 may be provided at a rate corresponding to a frame rate used by the client device to display images. Each of the blocks 520-524 may include information indicating the characteristics of each tile or pixel or the blocks 520-524 may use a compression scheme to reduce the amount of information that is transmitted. For example, the blocks 520-524 may be used to transmit intra-coded frames (I-frames) that are coded without reference to any frame except themselves, predicted frames (P-frames) that require prior decoding of at least one other previous frame to be decoded, and bi-directional predicted frames (B-frames) that require decoding of at least one other previous or subsequent frame to be decoded.

The time series 503 depicts blocks 530, 531, 532, 533 (referred to collectively herein as “the blocks 530-533”) that represents transfer of feedback information transmitted from the client device to the server. Some embodiments of the feedback information include motion data acquired by the client device that represents movement of the client device. The blocks 530-533 may be transmitted at approximately the same frequency as the blocks 520-524 so that the server can render the portions of the images used to generate the information in the blocks 520-524 based on the most recently acquired motion data.

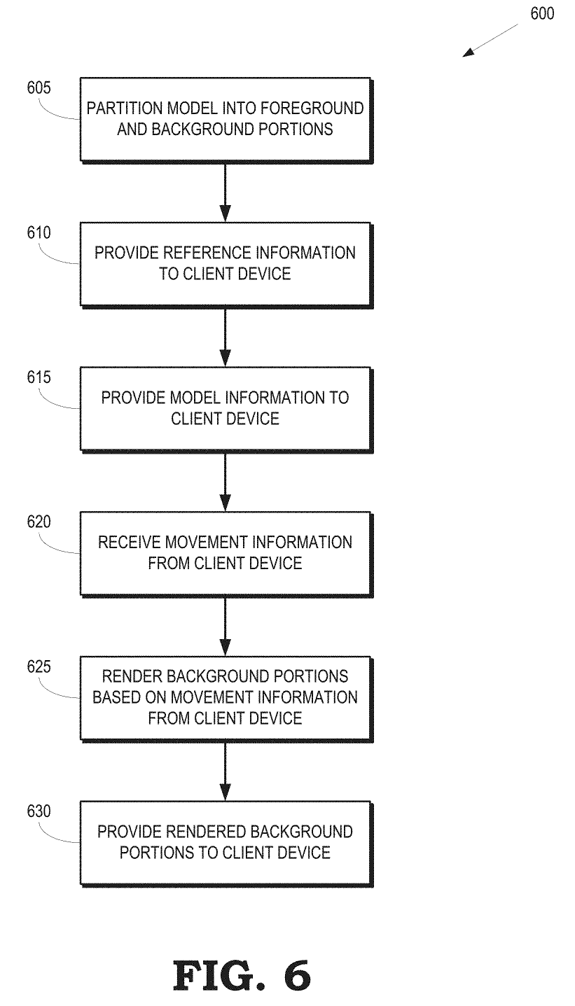

FIG. 6 is a flow diagram of a method 600 for partitioning a model into background and foreground portions and rendering the background portion according to some embodiments. The method 600 may be implemented by some embodiments of the server 105 shown in FIG. 1 or the server 213 shown in FIG. 2.

At block 605, the server partitions a model representative of a VR or AR scene into a foreground portion and a background portion. As discussed herein, the server may partition the model based on a threshold distance so that the foreground portion includes objects of the model that are less than the threshold distance from the client device and the background portion includes objects of the model that are further than the threshold distance from the client device. Rates of change of portions of the model may also be used to partition the model, e.g., by including portions with a higher rate of change in the foreground portion and a lower rate of change in the background portion.

At block 610, the server provides reference information to the client over an air interface. Some embodiments of the reference information include a common coordinate system that is shared by the foreground and background portions and is used to identify locations within the model. At block 615, the server provides model information to the client over the air interface. The model information includes information defining the foreground portion of the model. At block 620, the server receives movement information from the client device over the air interface. The movement information includes movement data that represents changes in the position or orientation of the client device as measured by the client device. The actions indicated by the blocks 610, 615, 620 may be performed in a different order or with different frequencies. For example, reference information may be provided (at block 610) less frequently than providing the model information (at block 615) or receiving the movement information (at block 620).

At block 625, the server renders the background portions of the image based on the background portions of the model. Some embodiments of the server render the background portions of the image based on movement data included in the feedback received from the client device at block 620. At block 630, the server provides the rendered background portions of the image to the client device so that the client device can merge the rendered background portions of the image with the foreground portions of the image that are rendered at the client device. Some embodiments of the method 600 are iterated in one or more loops that are performed at one or more frequencies. For example, the actions at the blocks 620, 625, 630 may be iterated in a loop that is performed at a frequency that corresponds to a frame rate used by the client device to display images. Some embodiments of the method 600 are performed in response to events detected by the server. For example, the actions indicated by the blocks 605 and 615 may be performed in response to determining that the foreground or background portions of the model have changed due to motion of the client device or the portions of the model.

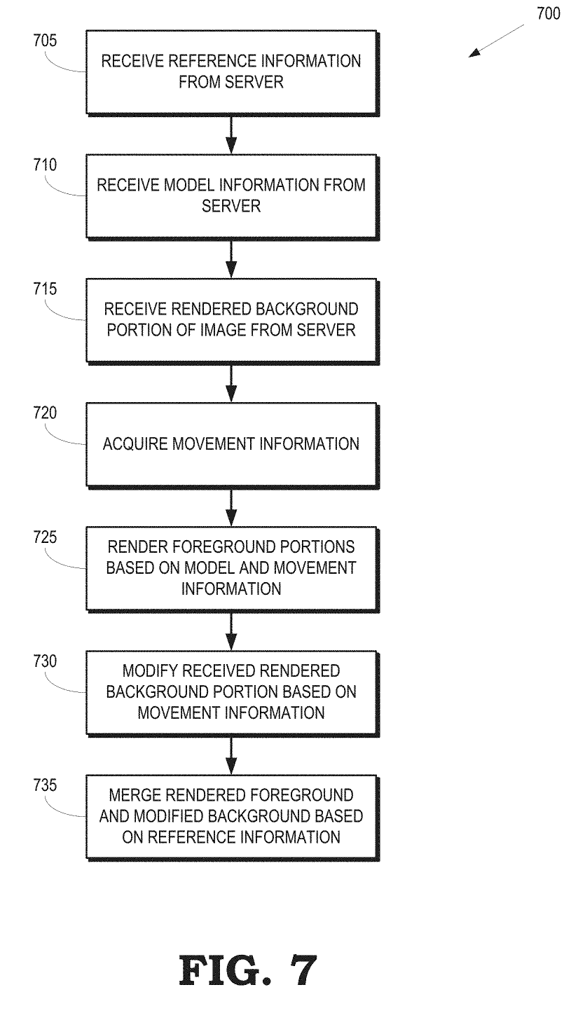

FIG. 7 is a flow diagram of a method 700 for rendering a foreground portion of an image from a corresponding foreground portion of a model and merging the rendered foreground portion with a background portion of the image that is rendered on a server according to some embodiments. The method 700 may be implemented by some embodiments of the server 105 shown in FIG. 1 or the server 213 shown in FIG. 2.

At block 705, the client device receives reference information from the server over an air interface. As discussed herein, the reference information may include a common coordinate system used to align the foreground and background portions of the image. At block 710, the client device receives model information from the server over the air interface. The model information is used to define a foreground portion of the model. At block 715, the client device receives the rendered background portion of the image from the server over the air interface.

At block 720, the client device acquires movement information. For example, the client device may implement one or more accelerometers, GPS devices, and the like that are used to measure or otherwise determine the position and orientation of the client device. Motion data may also be acquired from other devices such as motion-capture devices that are connected to the client device. The client device may also use these elements to determine a rate of change of the position or the orientation of the client device. Some embodiments of the client device provide this information as feedback to the server.

At block 725, the client device renders the foreground portions of the image based on the foreground portions of the model and the movement information acquired by the client device. At block 730, the client device modifies the received background portions of the image based on the movement information acquired by the client device. For example, the client device may apply a time warp to the received background portion to account for changes in the position or orientation of the client device that occurred after the last feedback of movement information was provided to the server.

At block 735, the client device merges the rendered foreground portion and the modified background portion of the image based on the reference information received at block 705. For example, the client device may use the reference information to align the rendered foreground portion and the modified background portion of the image. Some embodiments of the client device may also receive and utilize relational information that indicates the relations of the foreground and background portions of the image, as discussed herein.

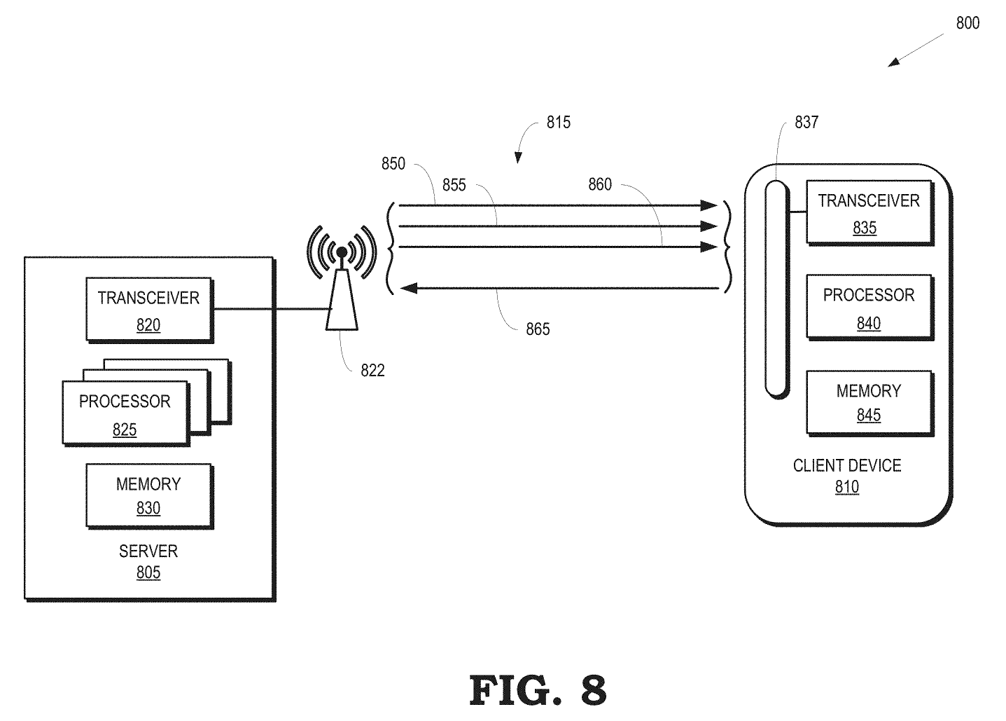

FIG. 8 is a block diagram of a wireless image processing and display system 800 that implements hybrid client/server rendering according to some embodiments. The system 800 includes a server 805 and a client device 810 that communicate over an air interface 815. The server 805 and the client device 810 may be used to implement some embodiments of the server 105 and client device 115 shown in FIG. 1 or the server 213 and the client device 205 shown in FIG. 2.

The server 805 includes a network interface such as a transceiver 820 for transmitting and receiving signals over the air interface 815. For example, the transceiver 820 may be connected to a base station 822 that is configured to transmit or receive signals over the air interface 815. The server 805 also includes one or more processors 825 and a memory 830. Some embodiments of the processors 825 are graphics processing units (GPUs) that are used to perform graphics processing functions such as rendering images. The processors 825 may be used to execute instructions stored in the memory 830 and to store information in the memory 830 such as the results of the executed instructions. The transceiver 820, the processors 825, and the memory 830 may be configured to perform some of embodiments of the method 600 shown in FIG. 6.

The client device 810 includes a network interface such as a transceiver 835 that is connected to an antenna 837 for transmitting and receiving signals over the air interface 815. The client device 810 also includes a processor 840 and a memory 845. The processor 840 may be used to execute instructions stored in the memory 845 and to store information in the memory 845 such as the results of the executed instructions. The transceiver 835, the processor 840, and the memory 845 may be configured to perform some embodiments of the method 700 shown in FIG. 7.

The air interface 815 may support uplink or downlink communication over one or more channels. For example, the air interface 815 may support a first downlink channel 850 that is used to transmit information such as a coordinate system that is used to align images rendered by the server 805 and the client device 810. The air interface 815 may also support a second downlink channel 855 that is used to transmit information defining a portion of a model that is used by the client device 810 to render a corresponding portion of the image. The air interface 815 may further support a third downlink channel 860 that is used to transmit rendered graphics that represent a portion of the image rendered by the server 805. An uplink channel 865 of the air interface 815 may be used to transmit feedback information such as motion data acquired by the client device 810.

Some embodiments of the wireless image processing and display system 800 provide an application programming interface (API) that defines a set of routines, protocols, and tools for configuring the server 805 or the client device 810. The API may define multiple rendering resources that are available to applications, such as the processors 825, 840. Programmers may therefore use the API to allocate the processors 825, 840 that are used by the application to render different portions of an image. The API may also define multiple rendering targets available to the application, such as tiles in foreground or background portions of an image. Programmers may use the API to allocate resources such as the processors 825, 840 to render portions of the image corresponding to the tiles associated with objects defined by the model of the image. The API may also define the common coordinate system that provides physical alignment between portions of the image rendered by the server 805 and the client device 810. The API may further define relational information that allows rendered portions of the images to reference each other. The API may further define mechanisms used by the client device 810 to collapse and merge the images rendered by the server 805 and the client device 810 into a single merged image. The API may further define lighting or filtering methodologies that are used to support continuity between the images rendered by the server 805 and the client device 810.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
at least one processor to partition a model representative of a scene into a first portion and a second portion based on proximities of the first portion and the second portion of the model to a client device and to render a first portion of an image representing the scene based on the first portion of the model; and
a network interface to transmit information representative of the second portion of the model and the rendered first portion of the image to the client device.

2. The apparatus of claim 1, wherein the first portion of the model represents objects of the scene that are beyond a threshold distance from the client device, and wherein the second portion of the model represents objects of the scene that are within the threshold distance from the client device.

3. The apparatus of claim 2, wherein the at least one processor is to partition the model into the first portion and the second portion further based on rates of change of the first portion and the second portion.

4. The apparatus of claim 3, wherein the at least one processor is to partition the model so that the first portion of the model has a rate of change that is below a threshold rate and the second portion of the model has a rate of change that is above the threshold rate.

5. The apparatus of claim 1, wherein the network interface is to transmit information indicating a coordinate system that is used to align the first portion of the image with a second portion of the image rendered by the client device using the second portion of the model.

6. The apparatus of claim 1, wherein the network interface is to receive motion data indicative of motion of the client device.

7. The apparatus of claim 6, wherein the at least one processor is to render the first portion of the image based on the first portion of the model and the motion data.

8. An apparatus comprising:
a network interface to receive information representative of a first portion of a model representative of a scene and a first portion of an image rendered by the server based on a second portion of the model, wherein the model is partitioned into the first portion and the second portion based on proximity of objects in the scene represented in the first and second portions to the apparatus; and
at least one processor to render a second portion of the image based on the first portion of the model and merge the first and second portions of the image.

9. The apparatus of claim 8, wherein the first portion of the model represents one or more objects of the scene that are within a threshold distance from the apparatus, and wherein the second portion of the model represents one or more objects of the scene that are beyond the threshold distance from the apparatus.

10. The apparatus of claim 9, wherein the model is partitioned into the first portion and the second portion further based on rates of change of the first portion and the second portion.

11. The apparatus of claim 10, wherein the model is partitioned into the first portion of the model that has a rate of change that is above a threshold rate and the second portion of the model that has a rate of change that is below the threshold rate.

12. The apparatus of claim 8, wherein the transceiver is to receive information indicating a coordinate system that is used to align the first portion of the image with the second portion of the image.

13. The apparatus of claim 8, wherein the at least one processor is to acquire motion data indicative of motion of the apparatus.

14. The apparatus of claim 13, wherein the at least one processor is to render the second portion of the image based on the first portion of the model and the motion data.

15. The apparatus of claim 14, wherein the at least one processor is to modify the first portion of the image based on the motion data prior to combining the first portion of the image with the second portion of the image.

16. The apparatus of claim 13, wherein the network interface is to transmit the acquired motion data to the server.

17. The apparatus of claim 8, further comprising:
at least one display, and wherein the at least one processor is to provide information indicative of the merged first and second portions of the image to the display for presentation to a user.

18. An apparatus comprising:
a server to partition a model representative of a scene into a first portion and a second portion based on proximities of objects in the scene to a client device, render a first portion of an image representative of the scene based on the first portion of the model, and transmit information representative of the second portion of the model and the first portion of the image, and
a client device to receive, from the server, information representative of the second portion of the model and the first portion of the image, and wherein the client device is to render the second portion of the image based on the second portion of the model and combine the first and second portions of the image.

19. The apparatus of claim 18, wherein the server is to transmit, to the client device, information indicating a coordinate system that is used to align the first portion of the image with the second portion of the image.

20. The apparatus of claim 18, wherein the client device is to acquire motion data indicative of motion of the client device and transmit information indicative of the motion data to the server, wherein the server is to render the first portion of the image based on the first portion of the model and the motion data, wherein the client device is to render the second portion of the image based on the second portion of the model and the motion data, and wherein the client device is to modify the first portion of the image based on the motion data prior to combining the first portion of the image with the second portion of the image.
